(19) United States
(12) Patent Application Publication
(10) Pub. No.: US 2026/0243026 A1
(43) Pub. Date: Aug. 20, 2026

(54) COATING COLOR COMPOSITION

(71) Applicant: COATEX, Genay (FR)

(72) Inventors: Francis BONY, Quincieux (FR); Laurie PARRENIN, Villeneuve (FR)

(73) Assignee: COATEX, Genay (FR)

(21) Appl. No.: 19/489,495

(22) PCT Filed: Jun. 11, 2024
(86) PCT No.: PCT/FR2024/000064

§ 371 Date: Dec. 2, 2025

(30) Foreign Application Priority Data
Jun. 12, 2023 (FR) FR2305906

(51) Int. Cl. D21H 19/58; C09D 7/40; C09D 7/61; C09D 7/63; C09D 7/65; C09D 133/06

(52) U.S. Cl. CPC D21H 19/58; C09D 7/61; C09D 7/63; C09D 7/65; C09D 7/67; C09D 7/68; C09D 7/69; C09D 7/70; C09D 133/064

(57) ABSTRACT

An aqueous rheological agent combining a polyalkoxylated hydrophobic compound and a water-soluble copolymer prepared in the presence of a dialkyl sulfosuccinate derivative, and a paper coating color composition that includes an aqueous rheological agent. The paper coating color composition is used for the preparation of paper or cardboard. The aqueous rheological agent allows for effective control of the different viscosity components of the coating color, while improving the water retention of the composition.

The invention relates to a paper coating composition comprising in particular an aqueous rheological agent combining a polyalkoxylated hydrophobic compound and a water-soluble copolymer prepared in the presence of a dialkyl sulphosuccinate derivative. The invention also relates to the use of this composition in the preparation of paper or cardboard and to this aqueous rheological agent that enables the various viscosity ingredients of the paper coating colour to be effectively controlled, while improving its water retention.

In addition to improving the final properties of the paper prepared using these paper coating colours, it is also necessary to improve the conditions for preparing and using these paper coating colour compositions.

Moreover, these compositions must have viscosities at different shear gradients that allow them to be used effectively, particularly when applied to the surface of a sheet of paper. These compositions must have an apparent viscosity, thus at a low shear gradient, that is well suited to effective application.

Moreover, increasing the viscosities at high and low shear gradients can affect the migration of water and of water-soluble substances through the paper. This migration must be reduced as much as possible, in particular to avoid any change in the rheology of the unused paper coating colour that is recycled in the coating process. It is therefore necessary to properly control the water retention of the paper coating colour.

In addition, the viscosity of the compositions must be controlled and enable them to be easily pumped or filtered, especially in the feed circuits in the paper coating processes. The compositions for preparing paper coating colours comprise insoluble materials, in particular mineral particles. A high concentration of and a high solids content in these compositions are often desirable, although increasing the concentration or solids content increases the risk of viscosity drift, particularly at high shear gradients.

The possibility of using very small mineral particles effectively is also desirable, in particular to improve the optical properties of the paper. However, these very small mineral particles can disrupt the viscosity and stability of paper coating compositions.

These compositions must also limit or prevent settling of the particles used. They must also limit, and even prevent, foaming or splashing.

The compatibility of the various components of a paper coating colour must also be taken into account. It is particularly important to ensure good compatibility with the binding latex used.

Thickening copolymers are commonly used when preparing paper coating colours, as are rheological admixtures.

However, the known rheological agents do not always provide satisfactory solutions to these various problems. Document EP 2776518 describes a paper coating colour comprising a HASE polymer prepared in the presence of a sodium salt of fatty alcohol sulphate and of tert-dodecyl mercaptan or of n-dodecyl mercaptan. Document EP 3122791 describes a binding latex prepared in the presence of dialkyl sulphosuccinate with vinyl acetate, a monomer containing a silane group and with small amounts of acrylic acid and of (meth)acrylate ester. Document EP 2788549 describes the preparation of copolymers in the presence of sodium salts of dialkyl esters of sulphosuccinic acid.

There is therefore a need for improved rheological agents to provide paper coating compositions.

The aqueous paper coating composition according to the invention provides a solution to all or some of the problems of the compositions in the prior art. Thus, the invention provides an aqueous paper coating composition C comprising:
at least one aqueous rheological agent R comprising:
   at least one water-soluble copolymer P prepared by polymerisation reaction in the presence of at least one compound E chosen among dialkyl sulphosuccinate, dialkyl sulphosuccinate sodium salt and combinations thereof:
      of at least one compound (a) chosen among methacrylic acid, a methacrylic acid salt, a methacrylic acid oligomer, a methacrylic acid oligomer salt, acrylic acid, an acrylic acid salt, an acrylic acid oligomer, an acrylic acid oligomer salt, their salts and combinations thereof;
      of at least one compound (b) chosen among C₁-C₁₀-alkyl methacrylate, C₁-C₁₀-alkyl acrylate, styrene, vinyl caprolactam, vinyl acetate and combinations thereof;
   at least one compound F of formula I:

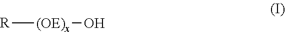

wherein R represents a straight C₆-C₄₀-alkyl group or a branched C₆-C₄₀-alkyl group, EO represents an oxyethylene group and x represents a number ranging from 1 to 50;
particles of at least one mineral material M;
at least one binding agent L and
water.

Preferably according to the invention, the composition C according to the invention comprises a polymer P prepared in the presence of a compound E chosen among dioctyl sulphosuccinate, dioctyl sulphosuccinate sodium salt and combinations thereof, optionally combined with at least one mercaptan compound. Preferably according to the invention, the mercaptan compound comprises a straight C₈-C₁₆-alkyl group or a branched C₈-C₁₆-alkyl group, more preferentially, the mercaptan compound is chosen among tert-nonyl mercaptan, tert-dodecyl mercaptan, n-dodecyl mercaptan and combinations thereof. More preferably, compound E is tert-nonyl mercaptan.

According to the invention, the polymer P is water-soluble, preferably at a pH greater than 5, more preferably at a pH greater than 6.

Preferably according to the invention, the polymer P has a molecular mass Mw, measured by SEC, ranging from 20,000 g/mol to 800,000 g/mol or from 20,000 g/mol to 500,000 g/mol, more preferably from 20,000 g/mol to 400,000 g/mol or from 20,000 g/mol to 300,000 g/mol.

According to the invention, the molecular mass Mw is determined by Size Exclusion Chromatography (SEC) or Gel Permeation Chromatography (GPC). This technique uses a “Waters” liquid chromatography instrument equipped with a detector. This detector is a “Waters” refractive index detector. This liquid chromatography instrument is equipped with a size exclusion column in order to separate the various molecular weights of the copolymers studied. The liquid elution phase is an aqueous phase adjusted to pH 9.00 using 1N sodium hydroxide containing 0.05 M of NaHCO₃, 0.1 M of NaNO₃, 0.02 M of triethanolamine and 0.03% of NaN₃.

According to a first step, the copolymer solution is diluted to 0.9% by dry weight in the dissolution solvent of the SEC, which corresponds to the liquid elution phase of the SEC to which 0.04% of dimethyl formamide, which acts as a flow marker or internal standard, is added. Then, it is filtered using a 0.2 μm filter. Then, 100 μL are injected into the chromatograph (eluent: an aqueous phase adjusted to pH 9.00 by 1N sodium hydroxide containing 0.05 M of NaHCO₃, 0.1 M of NaNO₃, 0.02 M of triethanolamine and 0.03% of NaN₃).

The liquid chromatography instrument has an isocratic pump (“Waters” 515), the flow rate of which is set to 0.8 mL/min. The chromatography instrument also comprises an oven, which itself comprises the following system of columns in series: a “Waters Ultrahydrogel Guard” precolumn measuring 6 cm in length and 40 mm in inner diameter and a “Waters Ultrahydrogel” linear column measuring 30 cm in length and 7.8 mm in inner diameter. The detection system consists of a “Waters RI” 410 refractometric detector. The oven is heated to 60° C. and the refractometer is heated to 45° C. The chromatography instrument is calibrated using sodium polyacrylate powder standards with different molecular masses certified by the supplier: Polymer Standards Service or American Polymers Standards Corporation (molecular mass ranging from 900 to 2,250,000 g/mol and polymolecularity index ranging from 1.4 to 1.7).

Preferably according to the invention, the polymer P is completely or partially acidic or completely or partially neutralised. More preferentially, the polymer P is partially neutralised, preferably using at least one compound chosen among LiOH, NaOH, KOH, Zn(OH)₂, Mg(OH)₂, Ca(OH)₂, ZnO, MgO, CaO, ammonium derivatives, ammoniac, ammonia, amino bases, for example triethanolamine, aminomethyl propanol or 2-amino-2-methyl-propanol (AMP) and combinations thereof. More preferentially, the polymer P is neutralised using LiOH, NaOH, KOH, Mg(OH)₂, Ca(OH)₂, ammonia and combinations thereof.

Essentially according to the invention, the polymer P is prepared by polymerisation reaction of at least one monomer (a) and of at least one monomer (b), in the presence of at least one compound E.

Preferably according to the invention, the monomer (a) is methacrylic acid alone or combined with acrylic acid. More preferentially, when using acrylic acid, the amount by mass of acrylic acid is less than the amount by mass of methacrylic acid.

Also preferably according to the invention, the monomer (b) is chosen among C₁-C₄-alkyl acrylate, C₁-C₄-alkyl methacrylate and combinations thereof. More preferentially, the monomer (b) is chosen among methyl acrylate, ethyl acrylate, propyl acrylate, isobutyl acrylate, n-butyl acrylate, methyl methacrylate, ethyl methacrylate, propyl methacrylate, isobutyl methacrylate, n-butyl methacrylate, aryl acrylate, in particular phenyl acrylate, benzyl acrylate, phenoxyethyl acrylate, aryl methacrylate, particularly preferably phenyl methacrylate, benzyl methacrylate, phenoxyethyl methacrylate and combinations thereof. Much more preferentially, it is chosen among methyl acrylate, ethyl acrylate, isobutyl acrylate, n-butyl acrylate, methyl methacrylate, even more preferentially chosen among methyl acrylate and ethyl acrylate.

In addition to monomers (a) and (b), the polymer P can also be prepared using one or more other monomers. Therefore, preferably according to the invention, copolymer P can be prepared by a polymerisation reaction also using at least one compound (c) of formula II:

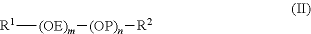

wherein:
   m or n is different than 0;
   m independently represents 0 or a number less than 150;
   n independently represents 0 or a number less than 150;
   EO represents an oxyethylene group;
   PO independently represents an oxypropylene group;
   R¹ represents a group comprising at least one polymerisable olefinic unsaturation, preferably a group chosen among acrylate, methacrylate, acryl urethane, methacryl urethane, vinyl, allyl, methallyl and isoprenyl, more preferentially a methacrylate group;
   R² represents a straight, branched or cyclical, saturated, unsaturated or aromatic hydrocarbon group comprising from 6 to 40 carbon atoms, preferably a straight or branched C₆-C₄₀ alkyl group, preferably a straight or branched C₈-C₃₀ alkyl group, a C₆-C₄₀ aryl group, preferably a C₈-C₃₀ aryl group, for example a tristyryl phenyl group.

Preferably according to the invention, the compound (c) is a compound of formula II wherein:
m represents an integer or decimal ranging from 20 to 40 and n is null, or
m and n independently represent an integer or decimal ranging from 5 to 100, or
the mass ratio m/n ranges from 90/10 to 70/30.

More preferably according to the invention, the compound (c) is a compound of formula II wherein:
m independently represents a number ranging from 2 to 50;
n independently represents 0;
EO represents an oxyethylene group;
R¹ represents a group comprising at least one polymerisable olefinic unsaturation, preferably a group chosen among acrylate, methacrylate, vinyl, allyl, methallyl and isoprenyl; more preferentially a methacrylate group;
R² represents a straight, branched or cyclical, saturated, unsaturated or aromatic hydrocarbon group comprising from 6 to 40 carbon atoms, preferably a straight or branched C₆-C₄₀ alkyl group, preferably a straight or branched C₈-C₃₀ alkyl group, a C₆-C₄₀ aryl group, preferably a C₈-C₃₀ aryl group, for example a tristyryl phenyl group.

According to the invention, the polymerisation reaction can also use at least one compound (d) chosen among:
polyalkylene glycol acrylate, preferably among polyethylene glycol acrylate and polyethylene-polypropylene glycol acrylate,
polyalkylene glycol methacrylate, preferably among polyethylene glycol methacrylate and polyethylene-polypropylene glycol methacrylate,
allyl polyalkylene glycol, preferably among allyl polyethylene glycol and allyl polyethylene-polypropylene glycol,
methallyl polyalkylene glycol, preferably among methallyl polyethylene glycol and methallyl polyethylene-polypropylene glycol,
3-methyl-3-buten-1-ylpolyalkylene glycol, preferably among 3-methyl-3-buten-1-ylpolyethylene glycol and 3-methyl-3-buten-1-ylpolyethylene-polypropylene glycol.

According to the invention, the polymerisation reaction can also use at least one cross-linking compound (e) or at least one compound (e) comprising at least two olefinic unsaturations. Nevertheless, preferably according to the invention, the polymerisation reaction does not use any compound (e).

According to the invention, the polymerisation reaction can also use at least one compound chosen among 2-acrylamido-2-methylpropane sulphonic acid, 2-sulphoethyl methacrylate, sodium methallyl sulphonate, styrene sulphonate, their salts and combinations thereof. Nevertheless, preferably according to the invention, the polymerisation reaction does not use any compound chosen among 2-acrylamido-2-methylpropane sulphonic acid, 2-sulphoethyl methacrylate, sodium methallyl sulphonate, styrene sulphonate and salts thereof.

The proportions of the different monomers used in the preparation of copolymer P can vary rather significantly. Preferably, copolymer P comprises, relative to the total amount by mass of monomers:
from 20% to 50% by mass of monomer (a) and from 50% to 80% by mass of monomer (b); or
from 35% to 44.9% by mass of monomer (a), from 55% to 74.9% by mass of monomer (b) and from 0.1% to 10% by mass of monomer (c); or
from 40% to 44.9% by mass of monomer (a), from 55% to 74.9% by mass of monomer (b) and from 0.1% to 5% by mass of monomer (d); or
from 40% to 44.9% by mass of monomer (a), from 55% to 74.9% by mass of monomer (b) and from 0.1% to 5% by mass of monomer (e); or
from 30% to 44.8% by mass of monomer (a), from 55% to 74.8% by mass of monomer (b), from 0.1% to 10% by mass of monomer (c) and from 0.1% to 5% by mass of monomer (d); or
from 30% to 44.8% by mass of monomer (a), from 55% to 74.8% by mass of monomer (b), from 0.1% to 10% by mass of monomer (c) and from 0.1% to 5% by mass of monomer (e); or
from 35% to 44.8% by mass of monomer (a), from 55% to 74.8% by mass of monomer (b), from 0.1% to 5% by mass of monomer (d) and from 0.1% to 5% by mass of monomer (e); or
from 25% to 44.7% by mass of monomer (a), from 55% to 74.7% by mass of monomer (b), from 0.1% to 10% by mass of monomer (c), from 0.1% to 5% by mass of monomer (d) and from 0.1% to 5% by mass of monomer (e).

Essentially according to the invention, the rheological agent R comprises at least one compound F of formula I. Preferably according to the invention, compound F is a compound of formula I wherein R represents a straight C₆-C₄₀-alkyl group, preferably a straight C₁₂-C₂₄-alkyl group.

Also preferably according to the invention, compound F is a compound of formula I wherein x represents a number ranging from 1 to 30, preferably a number ranging from 5 to 25. More preferentially according to the invention, R represents a straight C₆-C₄₀-alkyl group, preferably a straight C₁₂-C₂₄-alkyl group, and x represents a number ranging from 1 to 30.

More preferably according to the invention, compound F is a compound of formula I wherein x represents a number ranging from 1 to 30, preferably a number ranging from 5 to 25. More preferentially according to the invention, R represents a straight C₆-C₄₀-alkyl group, preferably a straight C₁₂-C₂₄-alkyl group, and x represents a number ranging from 5 to 25.

In addition to water, the rheological agent R according to the invention also comprises the water-soluble copolymer P and the compound F of formula I. The amounts of these compounds can vary. Preferably for the composition C according to the invention, the aqueous rheological agent R comprises from 0.05% to 5%, preferably from 0.1% to 2%, by dry mass of compound F, relative to the amount by dry mass of copolymer P.

In addition to water, the aqueous composition C according to the invention also comprises an aqueous rheological agent R, particles of at least one mineral material M and a binding agent L. The amounts of these ingredients can vary. Preferably according to the invention, the composition according to the invention comprises, relative to the amount by mass of the composition:
from 0.02% to 2% by dry mass of aqueous rheological agent R;
from 30% to 90% by dry mass of particles of mineral material M;
from 2% to 25% by dry mass of binding agent L and
from 7.98% to 44.98% by mass of water.

Essentially, the composition C according to the invention comprises a mineral material M in particulate form. Preferably according to the invention, the particles of mineral material M have a size of less than 50 μm or a size ranging from 0.05 μm to 50 μm or a size of less than 10 μm, preferably less than 5 μm or 2 μm, more preferentially less than 1 μm or less than 0.5 μm.

Also preferably according to the invention, the particles of mineral material M have an equivalent spherical diameter, for a size ranging from 0.05 μm to 50 μm or less than 50 μm, preferably for a size of less than 10 μm, more preferentially less than 5 μm or 2 μm, even more preferentially less than 1 μm or less than 0.5 μm, which is equal to 60% by weight or equal to 70% by weight.

More preferably according to the invention, the particles of mineral material M have an equivalent spherical diameter, for a size ranging from 0.05 μm to 50 μm or less than 50 μm, preferably for a size of less than 10 μm, more preferentially less than 5 μm or 2 μm, even more preferentially less than 1 μm or less than 0.5 μm, which is equal to 80% by weight or even equal to 90% by weight.

According to the invention, composition C can comprise a single mineral material M or comprise two or three mineral materials M. Preferably, composition C comprises a single mineral material M.

Preferably according to the invention, mineral material M is synthetic or of natural origin. More preferentially, it is chosen among alkaline earth metal carbonates, preferably calcium carbonate (natural calcium carbonate or precipitated calcium carbonate), strontium carbonate, magnesium carbonate, barium carbonate, dolomite, kaolin, titanium dioxide, talcum, lime, calcium sulphate, barium sulphate, silicas. More preferentially, material M is calcium carbonate (natural calcium carbonate or precipitated calcium carbonate) or kaolin.

Preferably according to the invention, the binding agent L is a natural binding agent such as starch, carboxymethyl cellulose (CMC), hydroxyethyl celluloses, polyvinyl alcohol (PVOH), casein, proteins, alginates, or a synthetic binding agent such as a latex. More preferentially, the binding agent L is chosen among a styrene-butadiene polymer, a styrene-acrylic polymer, a styrene-acetate polymer, much more preferentially a styrene-butadiene polymer.

In addition to the aqueous rheological agent R, the mineral material particles M and the binding agent L, composition C according to the invention can also comprise at least one admixture, in particular at least one admixture chosen among dispersing agents, anti-foaming agents, biocides, colouring agents, lubricants and optical brighteners.

Composition C according to the invention has several advantageous properties. These properties are particularly effective when preparing paper or cardboard. The invention therefore also provides a method of preparing paper or cardboard comprising the use of an aqueous composition C according to the invention. Preferably, this composition C is used in one or more paper or cardboard coating steps.

Paper coating colours prepared according to the invention are particularly advantageous when preparing a primary coating layer (pre-coat) or when preparing a final paper coating layer (top coat) or even a simple coat.

In addition, when using the paper or cardboard preparation method comprising the use of an aqueous composition according to the invention, the water retention of the composition during the paper coating step is improved. Preferably according to the invention, the water retention of composition C, measured according to the method used in the examples, during the paper coating step is improved by from 50% to 400% by volume relative to the non-use of copolymer P.

Also, when using the method of preparing paper or cardboard comprising the use of an aqueous composition C according to the invention, the viscosity of the composition is controlled by the properties of copolymer P. Preferably, the method according to the invention comprises the use of a composition C according to the invention that has a Brookfield viscosity, measured at 100 rpm and at 25° C. according to the method used in the examples, that is sufficient and compatible for the coating process and this viscosity is greater than that of the composition that is free from copolymer P.

More preferably according to the invention, the Brookfield viscosity of composition C, measured at 100 rpm and at 25° C. according to the method used in the examples, ranges from 150 mPa·s to 3,500 mPa·s, more preferentially from 500 mPa·s to 2,000 mPa·s. Also more preferably according to the invention, the capillary viscosity of composition C, measured at 1,000,000 s⁻¹ and at 25° C. according to the method used in the examples, ranges from 10 mPa·s to 100 mPa·s, more preferentially from 20 mPa·s to 80 mPa·s.

Also preferably when using the composition C according to the invention for preparing paper or cardboard, the composition is deposited on the surface of the paper or cardboard in at least one coating step with a coat weight, after drying, of from 5 to 50 g/m², more preferentially from 8 to 40 g/m², measured according to the method used in the examples. The coat weight can be applied using a blade or creaming method, a film transfer press, an air knife, a size press or a curtain coating process.

Essentially according to the invention, the aqueous paper coating composition C comprises the aqueous rheological agent R which gives it many desirable properties for the preparation of paper or cardboard, in particular the control of its viscosity and particularly of its viscosity at high shear gradient. Thus, the invention provides a method of controlling the high-gradient viscosity, measured at 1,000 000 s⁻¹ and at 25° C. according to the method used in the examples, of an aqueous paper coating composition C comprising particles of at least one mineral material M, at least one binding agent L and water, comprising the addition to the composition of at least one aqueous rheology agent R comprising:
at least one water-soluble copolymer P prepared by polymerisation reaction in the presence of at least one compound E chosen among dialkyl sulphosuccinate, dialkyl sulphosuccinate sodium salt and combinations thereof:
   of at least one compound (a) chosen among methacrylic acid, a methacrylic acid salt, a methacrylic acid oligomer, a methacrylic acid oligomer salt, acrylic acid, an acrylic acid salt, an acrylic acid oligomer, an acrylic acid oligomer salt and combinations thereof;
   of at least one compound (b) chosen among C₁-C₁₀-alkyl methacrylate, C₁-C₁₀-alkyl acrylate, styrene, vinyl caprolactam, vinyl acetate and combinations thereof;
at least one compound F of formula I:

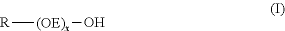

wherein R represents a straight C₆-C₄₀-alkyl group or a branched C₆-C₄₀-alkyl group, EO represents an oxyethylene group and x represents a number ranging from 1 to 50.

Essentially according to the invention, agent R combines copolymer P and compound F. According to the invention, agent R can be prepared prior to its introduction into an aqueous composition, preferably into an aqueous paper coating composition. According to the invention, agent R can also be prepared extemporaneously when introducing copolymer P and compound F into an aqueous composition, preferably into an aqueous paper coating composition.

The invention therefore also provides an aqueous rheological agent R combining:
at least one water-soluble copolymer P prepared by polymerisation reaction in the presence of at least one compound E chosen among dialkyl sulphosuccinate, dialkyl sulphosuccinate sodium salt and combinations thereof:
   of at least one compound (a) chosen among methacrylic acid, a methacrylic acid salt, a methacrylic acid oligomer, a methacrylic acid oligomer salt, acrylic acid, an acrylic acid salt, an acrylic acid oligomer, an acrylic acid oligomer salt and combinations thereof;
   of at least one compound (b) chosen among C₁-C₁₀-alkyl methacrylate, C₁-C₁₀-alkyl acrylate, styrene, vinyl caprolactam, vinyl acetate and combinations thereof;
at least one compound F of formula I:

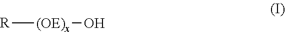

wherein R represents a straight C₆-C₄₀-alkyl group or a branched C₆-C₄₀-alkyl group, EO represents an oxyethylene group and x represents a number ranging from 1 to 50.

According to the invention, agent R can be prepared beforehand. Thus, the invention also provides an aqueous rheological agent R comprising:
at least one water-soluble copolymer P prepared by polymerisation reaction in the presence of at least one compound E chosen among dialkyl sulphosuccinate, dialkyl sulphosuccinate sodium salt and combinations thereof:
   of at least one compound (a) chosen among methacrylic acid, a methacrylic acid salt, a methacrylic acid oligomer, a methacrylic acid oligomer salt, acrylic acid, an acrylic acid salt, an acrylic acid oligomer, an acrylic acid oligomer salt and combinations thereof:
   of at least one compound (b) chosen among C₁-C₁₀-alkyl methacrylate, C₁-C₁₀-alkyl acrylate, styrene, vinyl caprolactam, vinyl acetate and combinations thereof;
at least one compound F of formula I:

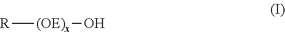

wherein R represents a straight C₆-C₄₀-alkyl group or a branched C₆-C₄₀-alkyl group, EO represents an oxyethylene group and x represents a number ranging from 1 to 50.

Preferably according to the invention, the aqueous rheological agent R comprises a polymer P and a compound F defined according to the invention.

The particular, advantageous or preferred characteristics of the composition C according to the invention define methods and agents R according to the invention that are also particular, advantageous or preferred.

The following examples make it possible to illustrate the various aspects of the invention, in particular the preparation and characterisation of paper coating compositions according to the invention.

### EXAMPLES

### Preparation of Polymers P1 and P2 According to the Invention and of Rheological Agents R1 and R2 According to the Invention:

The following compounds are used:
compound (a), AMA: methacrylic acid,
compound (b), EA: ethyl acrylate,
compound E, DOS: dioctyl sulphosuccinate 50% solution in water,
tert-nonyl mercaptan,
sodium persulphate, (NH₄)₂S₂O₈,
sodium metabisulphite, Na₂S₂O₅,
compound F1, Genapol T200 (Clariant): n-C₁₆-C₁₈-alkyl alcohol ethoxylated 20 times,
compound F2, Genapol UD088 (Clariant): oxo-C₁₁-alkyl alcohol ethoxylated 8 times.

In a stirred 1 L reactor heated with an oil bath, mixture 1 is prepared by introducing deionised water and a solution of dioctyl sulphosuccinate. A mixture 2 of monomers is prepared under stirring in a beaker, comprising, in deionised water:
monomer (a), AMA,
monomer (b), EA,
a 50% aqueous solution of dioctyl sulphosuccinate,
transfer agent, tert-nonyl mercaptan.

An initiator solution is prepared comprising ammonium persulphate, deionised water and sodium metabisulphite. The reactor is heated to 76±1° C., then the initiator solution is injected along with mixture 2 for 2 hours. The mixture is then heated for 1 hour at 80±1° C. The batch is then cooled to room temperature. Lastly, compound F is added. The reagents and amounts used, as well as the characteristics of polymers P1 and P2 and of agents R1 and R2, are shown in Table 1.

TABLE 1

| Amount (g) | | P1 and R1 | P2 and R2 | P3 and R3 |
|---|---|---|---|---|
| Mixture 1 | deionised water | 460.9 | 460.9 | 460.9 |
| | DOS | 9.57 | 9.57 | 9.57 |
| Mixture 2 | deionised water | 137 | 137 | 137 |
| | DOS | 1.45 | 1.45 | 1.45 |
| | AMA (a) | 108.5 | 108.5 | 108.5 |
| | EA (b) | 185 | 185 | 185 |
| | tert-nonyl mercaptan | 0.3 | 0.3 | 0.23 |
| Initiator | deionised water | 9.7 | 9.7 | 9.7 |
| | Ammonium persulphate | 0.902 | 0.902 | 0.902 |
| | Sodium metabisulphite | 0.09 | 0.09 | 0.09 |
| Polymer composition | monomer (a) (% by mass) | 37 | 37 | 37 |
| | monomer (b) (% by mass) | 63 | 63 | 63 |
| | compound F1 (g/100 g | 0.26 | 0.26 | 0 |
| | dry polymer) | | | |
| | compound F2 (g/100 g | 0 | 0 | 0.26 |
| | dry polymer) | | | |
| | mercaptan (ppm/amount | 1,000 | 0 | 750 |
| | of monomers) | | | |
| Characteristics | Final solids content | 30.1 | 30.1 | 30.1 |
| | (% by weight) | | | |

### Preparation and Characterisation of Compositions C1, C2 and C3 According to the Invention:

The pH is measured at 25° C. using a pH meter (WTW) with a conventional electrode coupled to a temperature probe.

The solids content is measured dry using a microwave balance (CEM). A piece of sandpaper is coated with composition at a weight assessed at between 1 and 4 g. Then it is dried in the microwave scales. The scales stop drying when the weight no longer changes for 10 seconds. The weight difference is expressed in %, which determines the solids content.

The Brookfield viscosity of the compositions prepared is measured at 100 rpm and at 25° C. using an analogue viscosity meter. The spindle is chosen according to the viscosity of the composition studied so as to be within the optimal range of the rheometer.

Capillary viscosity at 25° C. and at 10⁶ s⁻¹ is measured using a capillary viscometer (ACA ACAV A2).

Water retention is assessed at 25° C. using a retenometer (Gradek AAGWR) comprising a measuring chamber in which a test paper (Gradek Test Blotter Paper) is placed, covered by a perforated plastic sheet (Gradek PCTE Test Filter-2 μm). 10 mL of the composition are then introduced into the chamber. The AAGWR apparatus allows pressure (1.5 bar) to be applied to the composition, which causes all or part of the water and the water-soluble substances in the composition to pass through the perforated plastic sheet and migrate into the test paper. A pressure of 1.5 bar is applied for 90 seconds. The difference between the weight of the test paper before measuring (P0) and after measuring (P1) gives the amount of water and of water-soluble substances in the composition that migrated into the test paper during the measurement. The relative value of the increase in water retention is 1,250 x(P1-P0)/P0.

90 parts by mass of particles of material M (“Hydrocarb 95” calcium carbonate, “Omya”), 10 parts by mass of particles of a second material M (“Capim DG” kaolin, “Imerys”), 0.15 parts of a dispersing agent (“Topseperse GX N” sodium polyacrylate, “COATEX”), 10 parts of a binding agent L (DL 1066 styrene-butadiene latex, “Trinseo”), 0.5 part of an optical brightener (“Blankophor 4900”) are mixed under stirring.

This admixture has a solids content of 67%, a pH of 9 and a capillary viscosity of 60 mPa·s measured at 1,000,000 s⁻¹.

Composition C1 according to the invention is obtained by adding C, under stirring using a “V.M.I. Turbotest” motor, 0.2 part by mass of agent R1 to this mixture. The characteristics of composition C1 according to the invention are measured:
Brookfield viscosity at 100 rpm: 1,000 mPa·s,
water retention: 210 g/m²,
capillary viscosity: 65 mPa·s.

Similarly, composition C2 according to the invention, which is prepared using 0.2 parts by mass of agent R2, is prepared and characterised:
Brookfield viscosity at 100 rpm: 1,000 mPa·s,
water retention: 185 g/m²,
capillary viscosity: 65 mPa·s.

Similarly, composition C3 according to the invention, which is prepared using 0.2 part by mass of agent R3, is prepared and characterised:
Brookfield viscosity at 100 rpm: 950 mPa·s,
water retention: 210 g/m²,
capillary viscosity: 70 mPa·s.

Agents R1, R2 and R3 combining compounds F1 or F2 and, respectively, polymers P1, P2 and P3 according to the invention make it possible to prepare aqueous paper coating compositions C with a Brookfield viscosity that makes them easy to use when preparing the paper.

Agents R1, R2 and R3 are particularly effective in limiting capillary viscosity and improving water retention in the aqueous paper coating compositions C.

1. An aqueous paper coating composition C comprising:
an aqueous rheological agent R comprising:
a water-soluble copolymer P prepared by polymerisation reaction in the presence of at least one compound E selected from the group consisting of dialkyl sulphosuccinate and dialkyl sulphosuccinate sodium salt and including:
a compound (a) which is at least one selected from the group consisting of methacrylic acid, a methacrylic acid salt, a methacrylic acid oligomer, a methacrylic acid oligomer salt, acrylic acid, an acrylic acid salt, an acrylic acid oligomer, and an acrylic acid oligomer salt, and
a compound (b) which is at least one selected from the group consisting C₁-C₁₀-alkyl methacrylate, C₁-C₁₀-alkyl acrylate, styrene, vinyl caprolactam, and vinyl acetate;
a compound F of formula I: 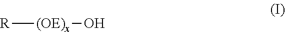
wherein R represents a straight C₆-C₄₀-alkyl group or a branched C₆-C₄₀-alkyl group, EO represents an oxyethylene group and x represents a number ranging from 1 to 50;
particles of a mineral material M;
a binding agent L; and
water.

2. The composition according to claim 1, wherein the copolymer P satisfies at least one criterion selected from the group consisting of:
the copolymer P is prepared in the presence of a mercapan compound;
the copolymer P is water-soluble at a pH greater than 5;
the copolymer P has a molecular mass Mw, measured by SEC, ranging from 20,000 g/mol to 800,000 g/mol; and
the copolymer P is completely or partially acidic or completely or partially neutralised.

3. The composition according to claim 1, wherein
the compound (a) is at least one selected from the group consisting of methacrylic acid and a combination of methacrylic acid and acrylic acid.

4. The composition according to claim 1, wherein the copolymer P is prepared by a polymerisation reaction which also uses:
at least one compound (c) of formula II: 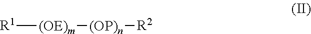
wherein:
m or n is different than 0;
m independently represents 0 or a number less than 150;
n independently represents 0 or a number less than 150;
EO represents an oxyethylene group;
PO independently represents an oxypropylene group;
R¹ represents a group comprising at least one polymerisable olefinic unsaturation; and
R² represents a straight, branched or cyclical, saturated, unsaturated or aromatic hydrocarbon group comprising from 6 to 40 carbon atoms.

5. The composition according to claim 1, wherein copolymer P comprises, based on a total amount by mass of monomers:
from 20% to 50% by mass of monomer (a) and from 50% to 80% by mass of monomer (b).

6. The composition according to claim 1, wherein compound F is a compound of formula I wherein R represents a straight C₆-C₄₀-alkyl group.

7. The composition according claim 1, comprising, based on a total mass of the composition:
from 0.02% to 2% by dry mass of aqueous rheological agent R;
from 30% to 90% by dry mass of particles of mineral material M;
from 2% to 25% by dry mass of binding agent L and
from 7.98% to 44.98% by mass of water.

8. The composition according to claim 1, wherein the composition satisfies at least one criterion selected from the group consisting of:
the particles of mineral material M have a size ranging from 0.05 μm to 50 μm;
an equivalent spherical diameter of the particles of mineral material M, for a size ranging from 0.05 μm to 50 μm is equal to 60% by weight;
the mineral material M is at least one selected from the group consisting of calcium carbonate, strontium carbonate, magnesium carbonate, barium carbonate, dolomite, kaolin, titanium dioxide, talcum, lime, calcium sulphate, barium sulphate, and silica;
the binding agent L is at least one selected from the group consisting of a starch, carboxymethyl cellulose (CMC), a hydroxyethyl cellulose, polyvinyl alcohol (PVOH), casein, a protein, an alginate, a latex, a styrene-butadiene polymer, a styrene-acrylic polymer, and a styrene-acetate polymer; and
the composition further comprises at least one admixture selected from the group consisting of a dispersing a agent, an anti-foaming agent, a biocide, a colouring agent, a lubricant, and an optical brightener.

9. A method of preparing paper or cardboard, the method comprising coating the paper or cardboard with the aqueous composition C according to claim 1.

10. The method according to claim 9, which satisfies at least one criterion selected from the group consisting of:
a water retention of composition C, during the coating is improved by from 50% to 400% by volume relative to a coating performed without the copolymer P.

11. A method of controlling high-gradient viscosity, measured at 1,000,000 s⁻¹ and at 25° C. of an aqueous paper coating composition C comprising
particles of at least one mineral material M,
at least one binding agent L, and
water, the method comprising
adding to the composition an aqueous rheological agent R comprising:
a water-soluble copolymer P prepared by polymerisation reaction in the presence of at least one compound E selected from the group consisting of dialkyl sulphosuccinate and dialkyl sulphosuccinate sodium salt and including
a compound (a) which is at least one selected from the group consisting of methacrylic acid, a methacrylic acid salt, a methacrylic acid oligomer, a methacrylic acid oligomer salt, acrylic acid, an acrylic acid salt, an acrylic acid oligomer, and an acrylic acid oligomer salt, and
a compound (b) which is at least one selected from the group consisting C₁-C₁₀-alkyl methacrylate, C₁-C₁₀-alkyl acrylate, styrene, vinyl caprolactam, and vinyl acetate; and
a compound F of formula I: 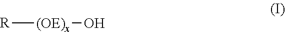
wherein R represents a straight C₆-C₄₀alkyl group or a branched C₆-C₄₀-alkyl group, EO represents an oxyethylene group and x represents a number ranging from 1 to 50.

12. An aqueous rheological agent R, comprising:
a water-soluble copolymer P prepared by polymerisation reaction in the presence of at least one compound E selected from the group consisting of dialkyl sulphosuccinateand dialkyl sulphosuccinate sodium salt and including
a compound (a) which is at least one selected from the group consisting of methacrylic acid, a methacrylic acid salt, a methacrylic acid oligomer, a methacrylic acid oligomer salt, acrylic acid, an acrylic acid salt, an acrylic acid oligomer, and an acrylic acid oligomer salt, and
a compound (b) which is at least one selected from the group consisting C₁-C₁₀-alkyl methacrylate, C₁-C₁₀-alkyl acrylate, styrene, vinyl caprolactam, and vinyl acetate; and
a compound F of formula I: 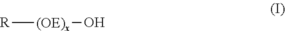
wherein R represents a straight C₆-C₄₀-alkyl group or a branched C₆-C₄₀-alkyl group, EO represents an oxyethylene group and x represents a number ranging from 1 to 50.

13. The aqueous rheological agent R according to claim 12, wherein the copolymer P satisfies at least one criterion selected from the group consisting of:
the copolymer P is prepared in the presence of a mercaptan compound;
the copolymer P is water-soluble at a pH greater than 5;
the copolymer P has a molecular mass Mw, measured by SEC, ranging from 20,000 g/mol to 800,000 g/mol; and
the copolymer P is completely or partially acidic or completely or partially neutralised.

14. The composition according to claim 1, wherein the compound (b) is at least one selected from the group consisting of a C1-C4 alkyl acrylate and a C1-C₄ alkyl methacrylate.

15. The composition according to claim 1, wherein the copolymer P is prepared by a polymerisation reaction which also uses:
a compound (d) which is at least one selected from the group consisting of a polyalkylene glycol acrylate, a polyalkylene glycol methacrylate, an allyl polyalkylene glycol, a methallyl polyalkylene glycol, and a 3-methyl-3-buten-1-ylpolyalkylene glycol.

16. The composition according to claim 1, wherein the copolymer P is prepared by a polymerisation reaction which also uses:
a cross-linking compound (e).

17. The composition according to claim 1, wherein compound F is a compound of formula I wherein x represents a number ranging from 1 to 30.

18. The composition according to claim 1, wherein the aqueous rheological agent R comprises from 0.05% to 5% of compound F, based on a total dry mass of copolymer P.

19. The method according to claim 9, which satisfies at least one criterion selected from the group consisting of:
a Brookfield viscosity of composition C, measured at 100 rpm and at 25° C., ranges from 150 mPa·s to 3,500 mPa·s;
a capillary viscosity of composition C, measured at 1,000,000 s- and at 25° C., ranges from 10 mPa·s to 100 mPa·s; and
composition C is deposited on a surface of the paper or of the cardboard in a deposit, measured after drying, of from 5 to 50 g/m².
